(19) United States
(12) Patent Application Publication
(10) Pub. No.: US 2010/0166976 A1
(43) Pub. Date: Jul. 1, 2010

(54) Method of manufacturing core-shell nanostructure

(75) Inventors: Wen-Yang Lin, Taipei City (TW); Ruoh-Huey Uang, Hsinchu (TW)

Correspondence Address: J C PATENTS, 4 VENTURE, SUITE 250, IRVINE, CA, 92618, US

(73) Assignee: Industrial Technology Research Institute, Hsinchu (TW)

(21) Appl. No.: 12/454,793

(22) Filed: May 22, 2009

(30) Foreign Application Priority Data
Dec. 30, 2008 (TW) 97151444

(51) Int. Cl. C08F 2/48; C08J 7/04; B05D 7/14

(52) U.S. Cl. 427/512; 427/521; 977/890

(57) ABSTRACT

A method for manufacturing core-shell nanostructure is provided. A nanoparticle containing a metal is provided. The nanoparticle is capable of transforming the light energy to the thermal energy. The nanoparticle is distributed onto a first thermosetting material precursor. A second thermosetting material precursor is coated on the first thermosetting material precursor to cover the nanoparticle. The nanoparticle is irradiated by a light source to produce the thermal energy such that the first thermosetting material precursor and the second thermosetting material precursor around the nanoparticle are cured to form a material layer on the nanoparticle. The uncured portion of the first thermosetting material precursor and the uncured portion of the second thermosetting material precursor are removed.

### CROSS-REFERENCE TO RELATED APPLICATION

This application claims the priority benefit of Taiwan application serial no. 97151444, filed on Dec. 30, 2008. The entirety of the above-mentioned patent application is hereby incorporated by reference herein and made a part of this specification.

### BACKGROUND OF THE INVENTION

1. Field of Invention

The present invention relates to a method for manufacturing a core-shell nanostructure. More particularly, the present invention relates to a method with using the photo-thermal effect of the nanoparticle to manufacture a core-shell nanostructure.

2. Description of Related Art

Because the nano-size material possesses particular dimension, composition and shape, nano-size material is different from the macroscopic material in the optical property, the electrical property and the chemical property.

Taking the gold nanoparticles widely used in the fields of the electronic technology, the optical technology and the biological technology as an example, when the gold nanoparticles are irradiated by the light with specific wavelength, the gold nanoparticles absorb the energy of the photon to polarize the free electron cloud. Thus, the electron cloud vibrates with the frequency of the photon to induce the particular surface plasmon resonance absorption. By using the surface plasmon resonance absorption phenomenon, the nanoparticles transform the light energy into the thermal energy, which is the photo-thermal effect of the nanoparticles.

Moreover, the core-shell nanoparticle is composed of two or more than two materials so that the novel functions and applications of the core-shell nanoparticles are newly created. The acknowledged core-shell nanoparticles is that the core composed of the inorganic substance or the organic substance is coated with a layer of the inorganic substance or the organic substance or with a double-layered structure or multi-layered structure of biomacromolecules. The core-shell nanoparticles can be classified into four species: the inorganic core with the organic outer layer, the inorganic core with the inorganic outer layer, the organic core with the inorganic outer layer and the organic core with the organic outer layer.

The properties of the nanoparticles can be changed, such as increasing the conductivity or magnetism, fine tuning the optical property of the core, increasing the stability of the core particle to prevent the aggregation of the core particles and increasing the resistance to the oxidation corrosion, by changing the material of the outer layer, so that the core-shell particles are widely used in the surface coating, special optical materials such as photon crystal and quantum dot, semiconductive fluorescent material, color clay ceramic, heat-dissipation material, super-high dielectric material and the biochemical catalyst of heterogeneous multienzyme. Also, if the core of the core-shell nanoparticle is further removed, the core-shell nanoparticle with a hollow construction can be applied for delivering or reserving the substance such as the medicine, the gene and the protein.

More particularly, in the current technologies, the core-shell nanostructure related to the metal nanoparticle can be classified into three species including the metal nanoparticle core with/the organic polymer outer layer (such as Au/polypyrrole), the metal nanoparticle core with/the inorganic outer layer (such as Au/SiO2) and the inorganic core with/the outer layer of metal nanoparticle (such as SiO2/Au). Furthermore, as for the synthesis method of core-shell nanostructure having the structure of the metal nanoparticle core with/the organic polymer outer layer, besides the use of the additional coupling agent and the initiator during the synthesis, it is necessary to perform the surface modification on the metal nanoparticle to graft the organic monomer, oligomer or un-crosslink polymer onto the metal nanoparticle surface before the synthesis for ensuring crosslink or polymerization reaction only occur on the surface of the nano-metal particle. So it is very important to accurately adjust the ratio of the organic monomer, oligomer or un-crosslink polymer to the metal nanoparticle and the functional group for grafting in order to obtaining optimal grafting ratio. The higher covering ratio of grafting on the metal nanoparticle surface, the better polymer coating of metal nanoparticle. Otherwise, the imperfect coating quality of polymer would lead dispersion of the core-shell nanostructure within the organic material more difficult. Thus, the application of the core-shell nanostructure is limited.

### SUMMARY OF THE INVENTION

Accordingly, the present invention is to provide a method for manufacturing a core-shell nanostructure by applying the photo-thermal effect of the nanoparticle to form a material layer selectively on the nanoparticle with good coating.

The invention provides a method for manufacturing core-shell nanostructure. The method comprises steps of providing a nanoparticle containing a metal which has surface plasmon resonance (SPR) absorption. The nanoparticle is capable of transforming the light energy which wavelength is in the range of SPR absorption spectrum to the thermal energy. The nanoparticle is distributed onto a first thermosetting material precursor. A second thermosetting material precursor is coated on the first thermosetting material precursor to cover the nanoparticle. The nanoparticle is irradiated by a light source which wavelength is in the range of SPR absorption spectrum to produce the thermal energy such that the first thermosetting material precursor and the second thermosetting material precursor around the nanoparticle are cured to form a thermosetting material layer on the nanoparticle. The uncured portion of the first thermosetting material precursor and the uncured portion of the second thermosetting material precursor are removed.

The invention further provides a method for forming a core-shell nanostructure. The method comprises steps of providing a nanoparticle containing a metal which has surface plasmon resonance (SPR) absorption. The nanoparticle is capable of transforming a light energy which wavelength is in the range of SPR absorption spectrum into a thermal energy. The nanoparticle is distributed onto a substrate. Then, a thermosetting material precursor is coated on the substrate to cover the nanoparticle. The nanoparticle is irradiated with a light source which wavelength is in the range of SPR absorption spectrum to produce the thermal energy so as to cure a portion of the thermosetting material precursor around the nanoparticle to form a thermosetting material layer on the nanoparticle. The uncured portion of the thermosetting material precursor is removed.

The present invention also provides another method for forming a core-shell nanostructure. The method comprises steps of providing a nanoparticle containing a metal which has surface plasmon resonance (SPR) absorption. The nanoparticle is capable of transforming a light energy which wavelength is in the range of SPR absorption spectrum into a thermal energy. Then, the nanoparticle is mixed with a thermosetting material precursor. The nanoparticle is irradiated with a light source which wavelength is in the range of SPR absorption spectrum to produce the thermal energy so as to cure a portion of the thermosetting material precursor around the nanoparticle to form a thermosetting material layer on the nanoparticle. The uncured portion of the thermosetting material precursor is removed.

In the present invention, the nanoparticle is irradiated by a light source and the nanoparticle is heated because of the photo-thermal effect of the nanoparticle by

SPR absorption so that the thermosetting material precursor around the nanoparticle is cured by the thermal energy generated by the nanoparticle so as to form a thermosetting material layer directly on the nanoparticle without further performing the surface modification such as grafting organic monomer, oligomer or un-crosslink polymer on the nanoparticle. Hence, the thermosetting material layer (shell) possesses better coating of the metal nanoparticle (core). Moreover, in the present invention, the thickness of the material layer can be adjusted by controlling the intensity of the light source and the irradiation time period and the shape of the core-shell nanostructure can be adjusted by controlling the shape of the nanoparticle.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A through 1D are cross-sectional views showing a method for forming a core-shell nanostructure according to an embodiment of the invention.

FIGS. 2A through 2D are cross-sectional views showing a method for forming a core-shell nanostructure according to another embodiment of the invention.

FIGS. 3A through 3C are cross-sectional views showing a method for forming a core-shell nanostructure according to the other embodiment of the invention.

FIG. 4A is a schematic diagram showing a gold nanoparticle on a PMMA substrate.

FIG. 4B is a plot diagram showing the temperature distribution of PMMA and air in FIG. 4A at different distances to bottom of PMMA substrate when the gold nanoparticle is irradiated.

FIG. 4C is a surface temperature distribution diagram of PMMA substrate. The center in this figure is the point of PMMA attached to the gold nanoparticle.

FIGS. 5A through 5D are scanning electron microscopy pictures of a manufacturing procedure for forming a polymer/gold core-shell nanoparticle.

FIG. 6 is a scanning electron microscopy picture of a polymer/silver core-shell nanoparticle.

FIG. 7 is a plot diagram showing the thermal energy distributions of CdSe nanoparticle, CdTe nanoparticle, Ag nanoparticle and Au nanoparticle irradiated by light with different wavelength.

FIG. 8 shows the calculated temperature increase at the surface of single Au nanoparticle in water is a function of illumination power at the plasmon resonance.

FIG. 9A is a plot diagram of the surface-plasmon-resonance (SPR) absorption vs. different sizes of Ag nanoparticle.

FIG. 9B is a plot diagram of the SPR absorption vs. different sizes of Ag nanorod.

### DESCRIPTION OF THE PREFERRED EMBODIMENTS

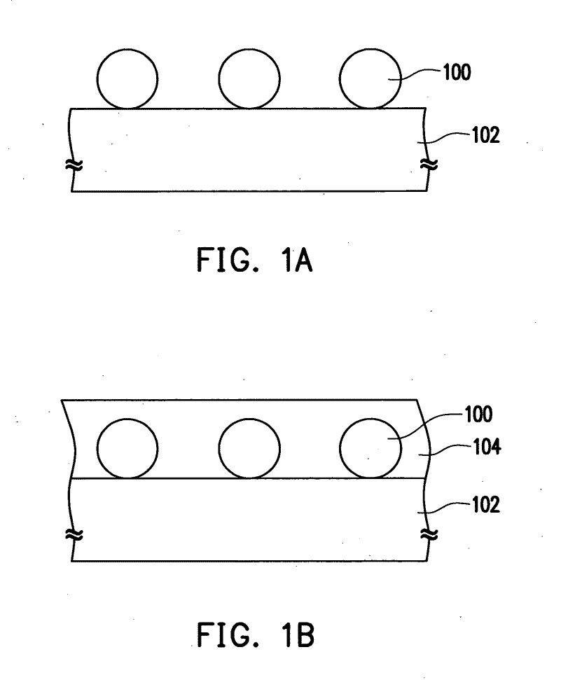

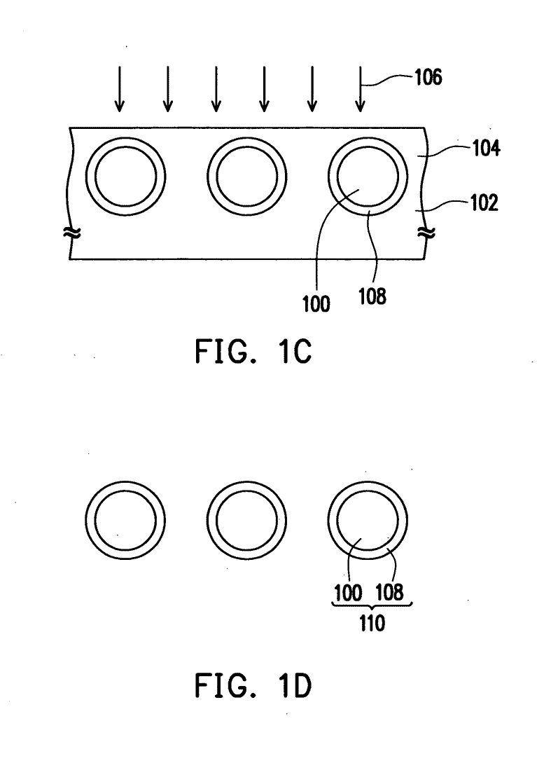

FIGS. 1A through 1D are cross-sectional views showing a method for forming a core-shell nanostructure according to an embodiment of the invention. As shown in FIG. 1A, at least one nanoparticle 100 is provided. The nanoparticles 100 contain metal and each of the nanoparticles 100 is capable of transforming the light energy into the thermal energy. The metal can be, for example but not limited to, silver, gold or copper. More particularly, the metal in each of the nanoparticles 100 can absorb light energy by light irradiation to induce the surface plasmon resonance so as to transform the absorbed light energy into the thermal energy. On the other words, each of the nanoparticles 100 possesses photo-thermal effect. Moreover, besides metal, each of the nanoparticles 100 further contains the inorganic substance or the organic substance. That is, besides the metal particle, each of the nanoparticles can also be the complex particle formed by the metal particle and the inorganic substance or the metal particle and the organic substance.

Still referring to FIG. 1A, a thermosetting material precursor 102 is provided. The thermosetting material precursor 102 can be, for example but not limited to, un-polymerized monomer, un-crosslink oligomer or un-crosslink polymer. For example, the thermosetting material precursor 102 can be epoxy, unsaturated polyester, phenolic resin or bismaleimide resin (BMI resin). Then, the nanoparticles 100 are distributed onto the thermosetting material precursor 102. The method for distributing the nanoparticles 100 onto the thermosetting material precursor 102 comprises printing, spin coating or dipping. In one embodiment, the nanoparticles 102 can be immobilized onto the thermosetting material precursor 102 through for example, chemical bonding, such as the covalent bonding or the ionic bonding, or physical adsorption, such as the electrostatic adsorption or the Van der Waals force.

Then, as shown in FIG. 1B, the thermosetting material precursor 102 is coated with a thermosetting material precursor 104 by dipping or spin or spray so as to cover the nanoparticles 100. The material of the thermosetting material precursor 104 is as same as the material of the thermosetting material precursor 102. Therefore, in this process step, each of the nanoparticles 100 is completely coated with the thermosetting material precursor.

Thereafter, as shown in FIG. 1C, the nanoparticles 100 are irradiated by a light source 106. The light source 106 can be, for example, laser or a light beam of the light emitting diode (LED). The wavelength of the light source 106 is suitable for the SPR absorption of nanoparticles 100 from the light source 106. Since each of the nanoparticles 100 possesses photo-thermal effect, each of the nanoparticles 100 can transform the light energy into the thermal energy after the nanoparticles 100 absorb the light energy. Furthermore, the thermosetting material precursor including the thermosetting material precursor 102 and the thermosetting material precursor 104 around each of the nanoparticles 100 is cured by absorbing the thermal energy produced by the nanoparticles 100 so as to form a thermosetting material layer 108 on each of the nanoparticles 100. The thickness of the material layer 108 is about 1˜100 nanometers. Furthermore, the thickness of the material layer can be well controlled by controlling the intensity of the light source 106 and the irradiation time period. More particularly, in the present embodiment, the shape of each of the nanoparticles 100 is sphericity. The shape of each of the nanoparticles 100 is not limited by the description made in this embodiment. That is, the shape of each of the nanoparticles 100 can be customized to be any other shapes such as cube shape, rod shape, prism shape or wire shape. Also, the shape of the material layer 108 formed on each of the nanoparticles 100 is as same as that of each of the nanoparticles 100.

Then, as shown in FIG. 1D, the uncured portion of the thermosetting material precursor is removed. The uncured portion of the thermosetting material precursor mentioned herein is the un-crosslink thermosetting material precursors 102 and 104. The method for removing the uncured portion of the thermosetting material precursor comprises steps of performing a cleaning process with a proper solvent which is determined by referring to the characteristic of the thermosetting material precursor in use. For example, un-crosslink epoxy can be removed by acetone. After the uncured portion of the thermosetting material precursor is removed, a core-shell nanostructure 110 composed of the nanoparticle 100 and the material layer 108 on the nanoparticle 100 is formed.

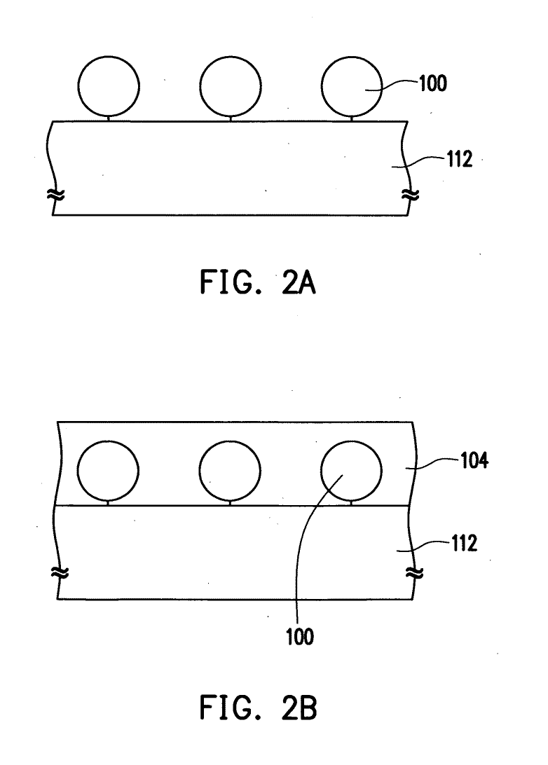

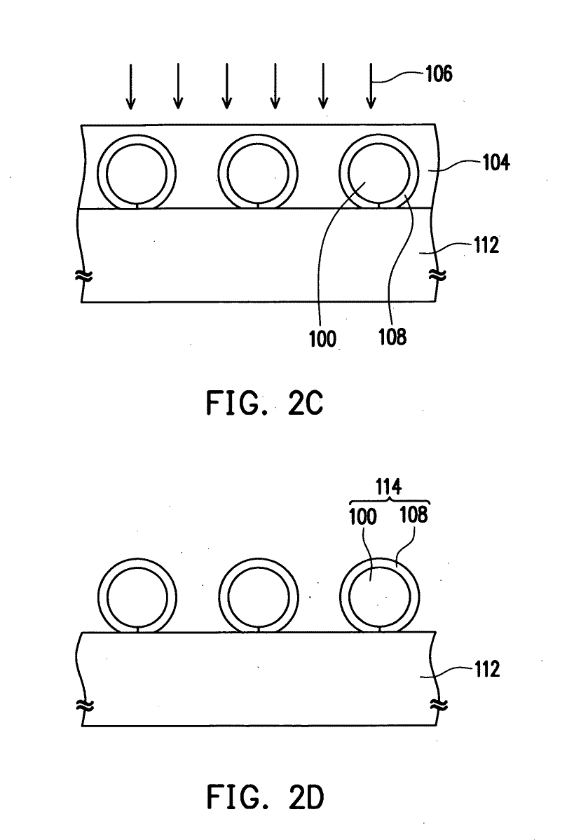

FIGS. 2A through 2D are cross-sectional views showing a method for forming a core-shell nanostructure according to another embodiment of the invention. In FIGS. 2A through 2D, the elements with the labeled numbers as same as those in FIGS. 1A through 1D indicate the same elements shown in FIGS. 1A through 1D so that the method for forming the same elements and the material of the same elements are not described herein. As shown in FIG. 2A, at least one nanoparticle 100 and a substrate 112 are provided. The substrate 112 can be, for example but not limited to, a glass substrate. Then, the nanoparticles 100 are distributed onto the substrate 112 by printing, spin coating or dipping. The nanoparticles 100 can be immobilized onto the substrate 112, by performing a plasma treatment with active ions impacting the substrate 112 so as to roughen the surface of the substrate 112 or by applying the self-assembly monolayer on substrate 112. Moreover, by performing the surface modification on each of the nanoparticles, the nanoparticles 100 can be immobilized onto the substrate surface through the chemical bonding, such as the ionic bonding or the covalent bonding (for example, the surface of the substrate is modified by COOH group, and then the surface of each of the nanoparticles is modified to be carrying positive ions such as NH₃⁺; alternatively, the surface of the substrate can be modified to be carrying positive ions and the surface of each of the nanoparticles is modified to be carrying negative ions).

Then, as shown in FIG. 2B, the substrate 112 is coated with a thermosetting material precursor 104 so that the thermosetting material precursor 104 covers each of the nanoparticles 100 by printing, spin coating or dipping.

As shown in FIG. 2C, the nanoparticles 100 are irradiated by a light source 106. The wavelength of the light source 106 is suitable for the SPR absorption of nanoparticles 100 from the light source 106. Since each of the nanoparticles 100 possesses photo-thermal effect, each of the nanoparticles 100 can transform the light energy into the thermal energy after the nanoparticles 100 absorb the light energy. Additionally, a portion of the thermosetting material precursor 104 around each of the nanoparticles 100 is cured by absorbing the thermal energy produced by the nanoparticles 100 so as to form a thermosetting material layer 108 on each of the nanoparticles 100. Similarly, the thickness of the material layer 108 can be adjusted by controlling the intensity of the light source 106 and the irradiation time period.

As shown in FIG. 2D, the uncured portion of the thermosetting material precursor 104 is removed. In the present embodiment, because the material of the substrate 112 is not the thermosetting material precursor, the substrate 112 is not removed with the removal of the uncured portion of the thermosetting material precursor. That is, after the uncured portion of the thermosetting material precursor 104 is removed, the core-shell nanostructure 114 composed of the nanoparticle 100 and the material layer 108 on the nanoparticle 100 is still distributed on the substrate 112.

More particularly, since the substrate 112 is not removed in the present embodiment, the position of the core-shell nanostructure 114 on the substrate 112 can be adjusted by controlling the distributed position of the nanoparticles 100 on the substrate 112 according to the practical requirement so as to form the device on demand.

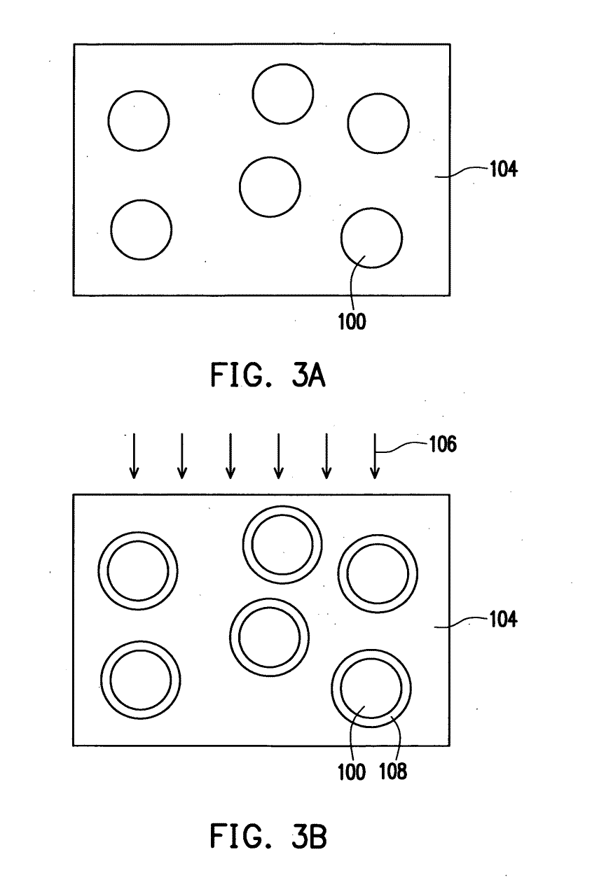

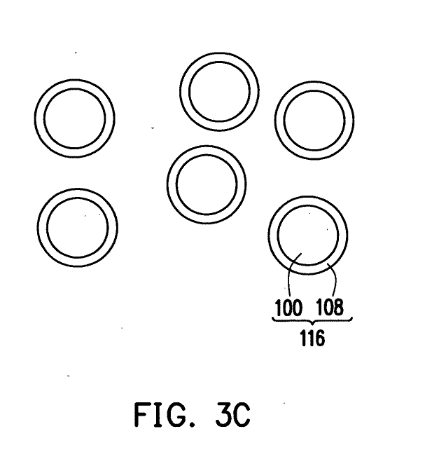

FIGS. 3A through 3C are cross-sectional views showing a method for forming a core-shell nanostructure according to the other embodiment of the invention. In FIGS. 3A through 3C, the elements with the labeled numbers as same as those in FIGS. 1A through 1D indicate the same elements shown in FIGS. 1A through 1D so that the method for forming the same elements and the material of the same elements are not described herein. As shown in FIG. 3A, at least one nanoparticle 100 and the thermosetting material precursor 104 are provided. Then, the nanoparticles 100 are mixed with the thermosetting material precursor 104.

As shown in FIG. 3B, the nanoparticles 100 are irradiated by the light source 106. The wavelength of the light source 106 is suitable for the SPR absorption of nanoparticles 100 from the light source 106. Since each of the nanoparticles 100 possesses photo-thermal effect, each of the nanoparticles 100 can transform the light energy into the thermal energy after the nanoparticles 100 absorb the light energy. Additionally, a portion of the thermosetting material precursor 104 around each of the nanoparticles 100 is cured by absorbing the thermal energy produced by the nanoparticles 100 so as to form a thermosetting material layer 108 on each of the nanoparticles 100. Similarly, the thickness of the material layer 108 can be adjusted by controlling the intensity of the light source 106 and the irradiation time period.

As shown in FIG. 3C, the uncured portion of the thermosetting material precursor 104 is removed so as to leave a core-shell nanostructure 116 formed from the nanoparticle 100 and the material layer 108 on the nanoparticle 100.

As for the aforementioned core-shell nanostructure 110, 114 and 116, since the material layer 108 is formed on each of the nanoparticles 100, the nanoparticles 100 can be easily distributed in the polymer matrix and it is benefit to effectively enhance the property of the polymer matrix under the condition of low mixing concentration. Furthermore, because the core of the core-shell nanostructure 110 contains metal, the thermal conductive coefficient is increased. Further, the material layer 108 on each of the nanoparticle 100 is capable of decreasing electron tunneling and leakage current. Consequently, the core-shell nanostructure 110 can be applied in the high dielectric material and the thermal conductive material.

The method for forming the core-shell nanostructure is further described in the following experiment embodiments.

### First Embodiment

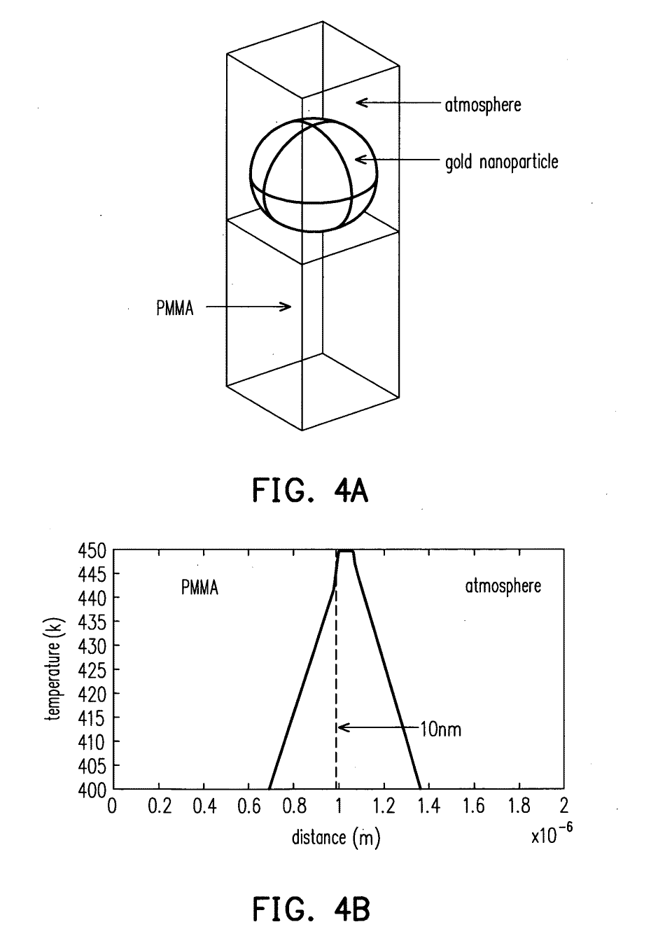

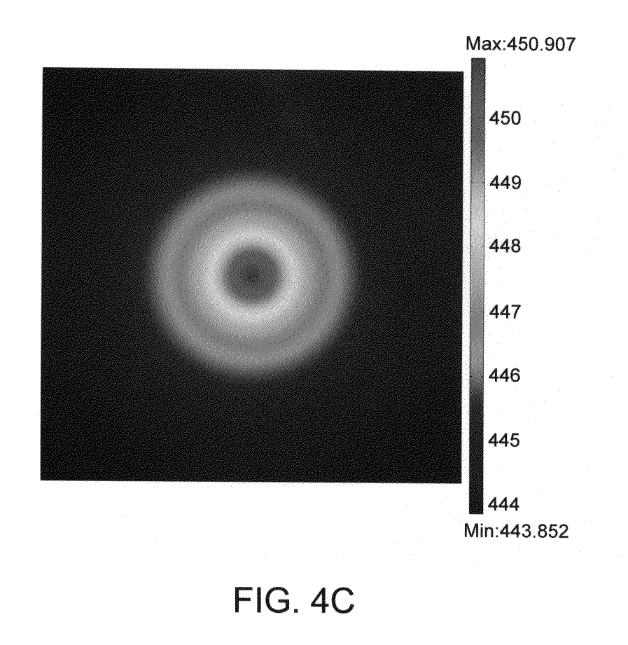

FIG. 4A is a schematic diagram showing a gold nanoparticle on a PMMA substrate. FIG. 4B is a plot diagram showing the temperature distribution of PMMA and air at different distances to bottom of PMMA substrate when the gold nanoparticle in FIG. 4A is irradiated. FIG. 4C is a surface temperature distribution diagram of PMMA substrate. The center in this figure is the point of PMMA attached to the gold nanoparticle. As shown in FIG. 4B, the temperature at the PMMA surface attached to the gold nanoparticle is highest and the temperature in PMMA will decrease as the distance to the gold nanoparticle increases. From FIG. 4B and FIG. 4C, the range of higher temperature in PMMA is located within 10 nm around the gold nanoparticle. So we can control the temperature of the gold nanoparticle by change light intensity to control the distribution of temperature around nanoparticles for obtaining polymer shell.

### Second Embodiment

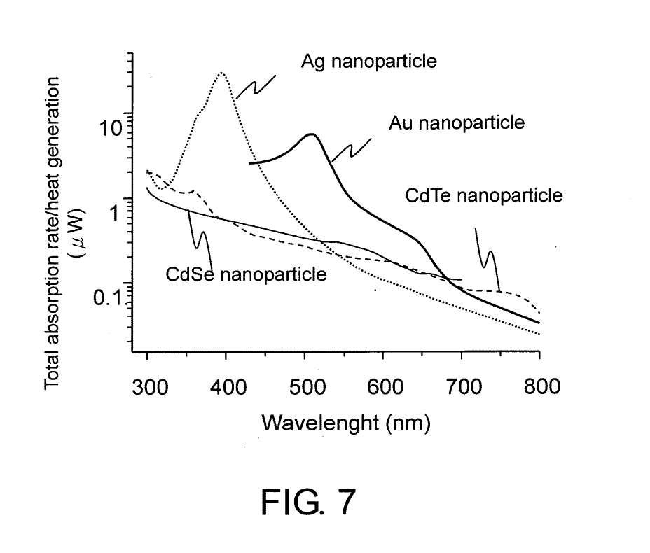

FIG. 7 is a plot diagram showing the thermal energy distributions of CdSe nanoparticle, CdTe nanoparticle, Ag nanoparticle and Au nanoparticle irradiated by light with different wavelength. Referring to FIG. 7, by comparing with CdSe nanoparticle and CdTe nanoparticle, Ag nanoparticle and Au nanoparticle generate a larger amount of the thermal energy when Ag nanoparticle and Au nanoparticle are irradiated by a beam with a specific wavelength, such as an absorption band for exciting SPR.

Photo-thermal effect relates to the absorption of SPR and SPR depends on the size, shape, and degree of particle-to-particle coupling.

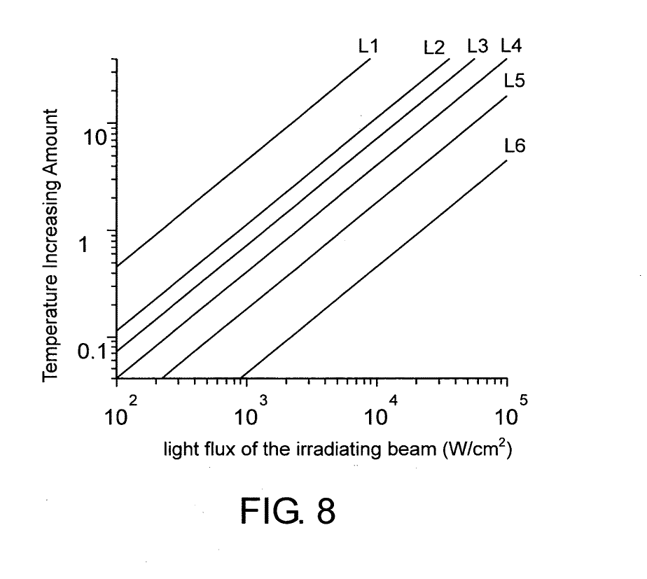

FIG. 8 shows the calculated temperature increase at the surface of single Au nanoparticle in water is a function of illumination power at the plasmon resonance. In FIG. 8, lines L1 through L6 represent the Au nanoparticles with particle sizes of 100 nm, 50 nm, 40 nm, 30 nm, 20 nm, and 10 nm in water individually irradiated by the beam with a wavelength of 520 nm (λ_{excitation}=520 nm) respectively. The vertical axle represents the temperate increasing amount (ΔTₘₐₓ) caused by the thermal energy generated by a single Au nanoparticle, and the unit is K. The lateral axle represents the light flux of the irradiating beam, and the unit is W/cm². It is clear, as shown in FIG. 8, the nanoparticle with relatively large size performances relatively better temperature increasing efficiency when the light flux of the irradiating beam is constant.

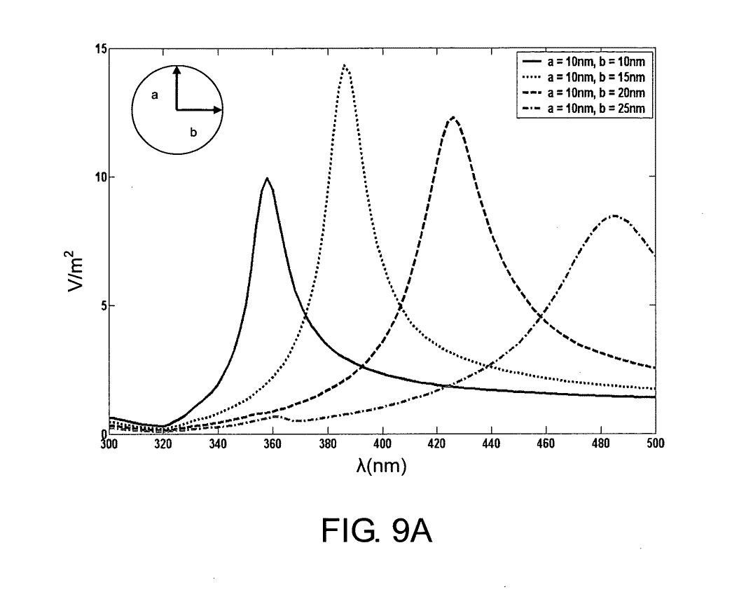

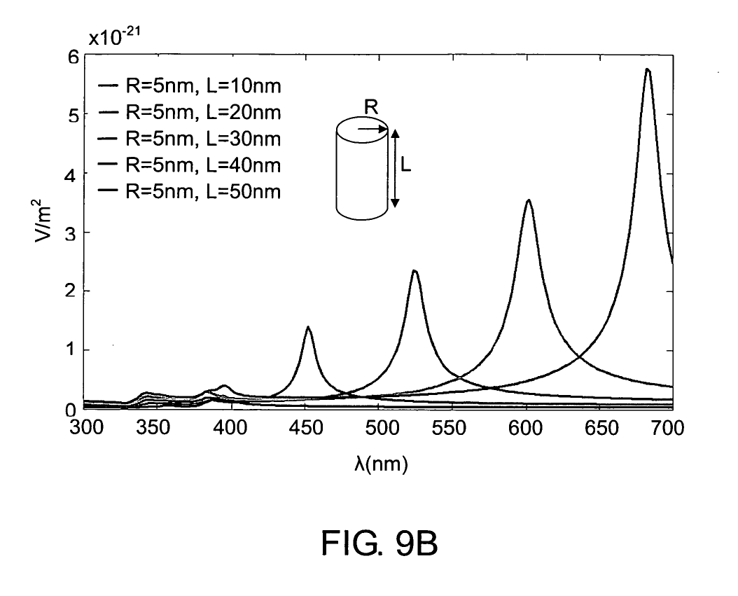

FIG. 9A is a plot diagram of the surface-plasmon-resonance (SPR) absorption vs. different sizes of Ag nanoparticle. FIG. 9B is a plot diagram of the SPR absorption vs. different sizes of Ag nanorod. By comparing FIG. 9A with FIG. 9B, it is clear that the absorption wavelength is different when the size and shape of the irradiated material are changed.

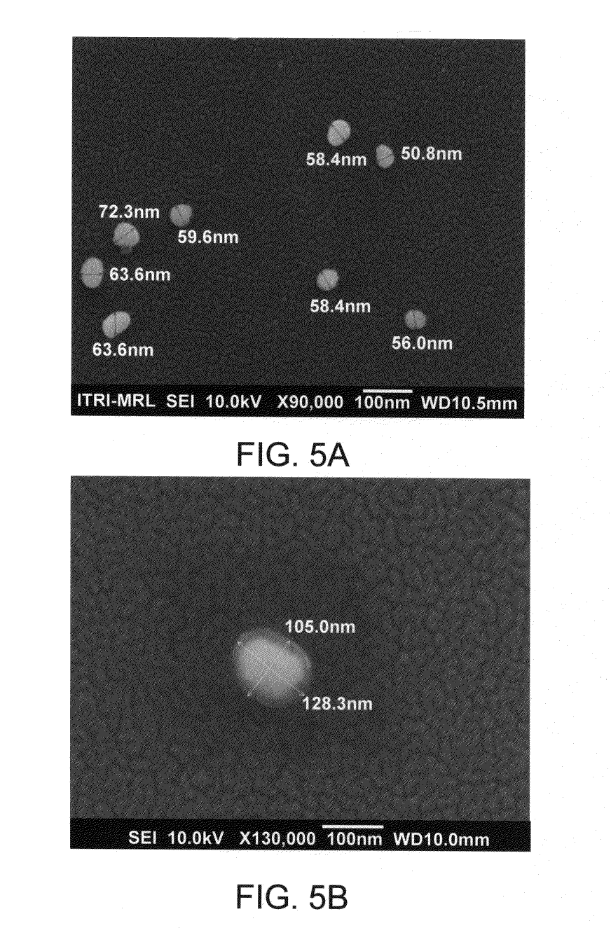

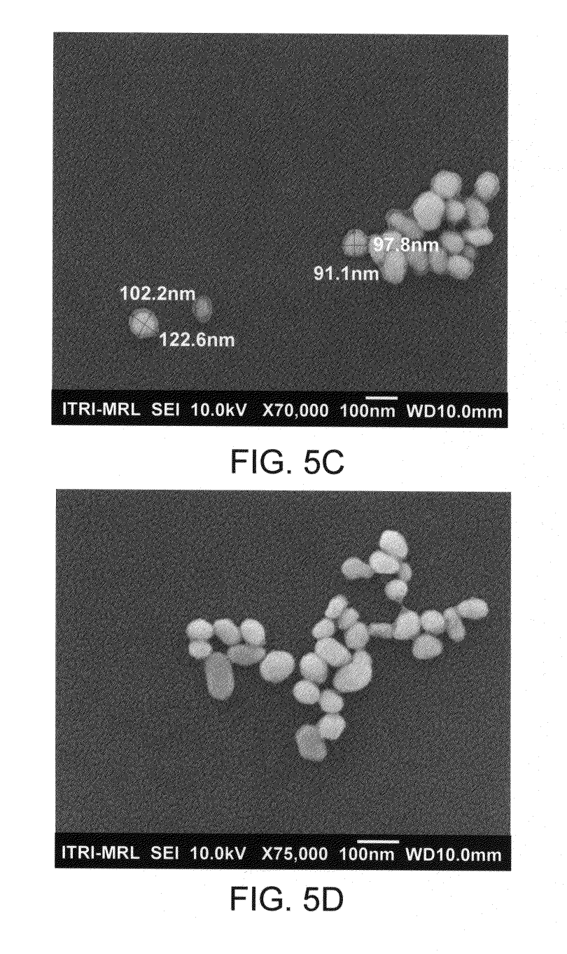

At least one gold nanoparticle with size of 60 nm and a glass substrate are provided. Then, the gold nanoparticles are distributed onto the glass substrate by using self-assembly monolayer, as shown in FIG. 5A. The process steps are described as followings.

The glass substrate is dipped into, for example but not limited to, the nitric acid and then is dipped into aqueous ethanol solution with a concentration of 5%. Thereafter, the 3-aminopropyltriethoxysilane (3APTES) solution, which can be diluted by alcohols, is used as a first binder in which there are three ends of ethoxy groups and one end of —NH₂ group and the glass substrate is dipped into the first binder. Then, the glass substrate is dipped into ethanol with a concentration of 5%. Thereafter, HS—(CH2)7-COOH, which can be diluted, is used as a second binder and the glass substrate is dipped into the second binder. Then, the glass substrate is dipped into ethanol with a concentration of 5%. At this point, the glass substrate becomes hydrophobic and has —SH group bonding thereon which can be covalent bonding with Au atom. Then, the solution having gold nanoparticles is dropped onto the glass substrate so that Au atoms are bonding with —SH groups on the glass substrate. The thermosetting material precursor is coated onto the glass substrate by spin coating so as to cover the gold nanoparticles. The spin coating mentioned above is performed with a rotation speed about 600 rpm for spinning about 15 second or a rotation speed about 1600 rpm for spinning about 25 second. The glass substrate is heated under 60 centigrade for about 12 minutes to dry out the solvent. Then, the gold nanoparticles are irradiated by green laser with a wavelength about 514 nm for about 80 minutes to heat up the gold nanoparticles so as to cure a portion of the thermosetting material precursor around the gold nanoparticles to form the thermosetting material layer on the gold nanoparticles, as shown in FIG. 5B and FIG. 5C. Additionally, the un-irradiated region is shown in FIG. 5D. Then, the glass substrate is dipped in to acetone for about 24 hours so as to remove uncured portion of the thermosetting material precursor to leave the core-shell nanostructure formed from the gold nanoparticle and the material layer on the gold nanoparticle on the glass substrate. The thickness of polymer around the gold nanoparticle is about 10 nm.

### Third Embodiment

At least one silver nanoparticle with size of 60 nm and a glass substrate are provided. Then, the silver nanoparticles are distributed onto the glass substrate by using self-assembly monolayer. The process steps are described as followings.

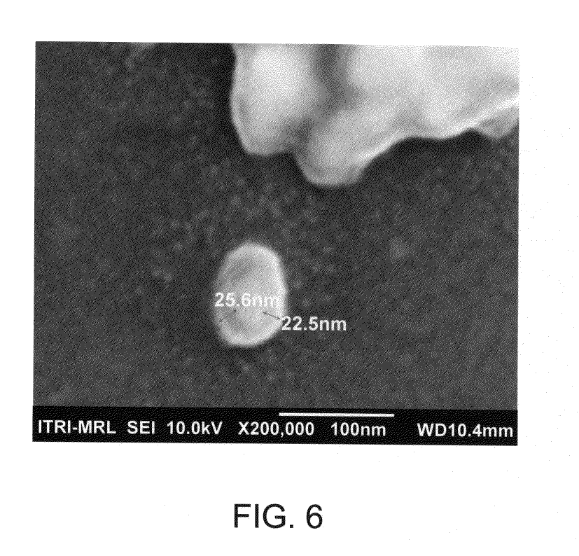

The glass substrate is dipped into, for example but not limited to, the nitric acid and then is dipped into ethanol with a concentration of 5%. Thereafter, the 3-aminopropyltriethoxysilane (3APTES) solution, which can be diluted by alcohols, is used as a first binder in which there are three ends of ethoxy groups and one end of —NH group and the glass substrate is dipped into the first binder. Then, the glass substrate is dipped into ethanol with a concentration of 5%. Thereafter, HS—(CH2)7-COOH, which can be diluted, is used as a second binder and the glass substrate is dipped into the second binder. Then, the glass substrate is dipped into ethanol with a concentration of 5%. At this point, the glass substrate becomes hydrophobic and has —SH group bonding thereon which can be covalent bonding with Ag atom. Then, the solution having silver nanoparticles is dropped onto the glass substrate so that Ag atoms are bonding with —SH groups on the glass substrate. The thermosetting material precursor is coated onto the glass substrate by spin coating so as to cover the silver nanoparticles. The spin coating mentioned above is performed with a rotation speed about 600 rpm for spinning about 15 second or a rotation speed about 1600 rpm for spinning about 25 second. The glass substrate is heated under 60 centigrade for about 12 minutes to dry out the solvent. Then, the silver nanoparticles are irradiated by blue laser with a wavelength about 408 nm and a power of 50 mW for about 20 minutes to heat up the silver nanoparticles so as to cure a portion of the thermosetting material precursor around the silver nanoparticles to form the thermosetting material layer on the silver nanoparticles. Then, the glass substrate is dipped in to acetone for about 24 hours so as to remove uncured portion of the thermosetting material precursor to leave the core-shell nanostructure formed from the silver nanoparticle and the material layer on the silver nanoparticle on the glass substrate (as shown in FIG. 6). Since the photo-thermal effect of silver is better than the photo-thermal effect of gold, the core-shell nanostructure from the silver nanoparticle can be formed with a relatively thick shell in a relatively short time. The thickness of polymer around the gold nanoparticle is about 20 nm.

Altogether, in the present invention, the nanoparticles containing the metal are distributed into the thermosetting material precursor and then the nanoparticles are irradiated by the light source. By using the photo-thermal effect of the nanoparticles, the nanoparticles are heated so that the thermosetting material precursor around the nanoparticles is cured by absorbing the thermal energy from the nanoparticles to form the thermosetting material layer directly on the nanoparticles without performing surface modification on the nanoparticles.

Moreover, since the material layer on the nanoparticles is formed from the thermosetting material precursor absorbing the thermal energy from the nanoparticles, the coating quality of the thermosetting material layer is relatively better. Accordingly, the distribution of the core-shell nanoparticles in the organic solution is relatively better.

Furthermore, in the present invention, the thickness of the material layer can be adjusted by controlling the intensity of the light source and the irradiation time period. Also, the shape of the core-shell nanostructure can be adjusted by controlling the shape of each of the nanoparticles.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A method for forming a core-shell nanostructure, comprising:
providing at least a nanoparticle containing a metal, wherein the nanoparticle is capable of transforming a light energy into a thermal energy;
distributing the nanoparticle onto a first thermosetting material precursor;
coating a second thermosetting material precursor on the first thermosetting material precursor to cover the nanoparticle;
irradiating the nanoparticle with a light source to produce the thermal energy so as to cure a portion of the first thermosetting material precursor and a portion of the second thermosetting material precursor around the nanoparticle to form a thermosetting material layer on the nanoparticle; and
removing the uncured portion of the first thermosetting material precursor and the uncured portion of the second thermosetting material precursor.

2. The method of claim 1, wherein the metal is selected from a group comprising silver, gold, copper, or the combination of which has surface plasmon resonance absorption.

3. The method of claim 1, wherein the nanoparticle further contains an inorganic substance or an organic substance.

4. The method of claim 1, wherein the first thermosetting material precursor is as same as the second thermosetting material precursor.

5. The method of claim 1, wherein the first thermosetting material precursor comprises un-polymerized monomer, un-crosslink oligomer and un-crosslink polymer.

6. The method of claim 1, wherein the second thermosetting material precursor comprises un-polymerized monomer, un-crosslink oligomer and un-crosslink polymer.

7. The method of claim 1, wherein the step for distributing the nanoparticle onto the first thermosetting material precursor comprises printing, spin coating and dipping.

8. The method of claim 1, wherein the step for immobilizing the nanoparticle onto the first thermosetting material precursor comprises chemical bonding and physical adsorption.

9. The method of claim 1, wherein the thickness of the material layer is about 1˜100 nanometers.

10. The method of claim 1, wherein the light source is selected from a group comprising a laser and a light beam of light emitting diode.

11. A method for forming a core-shell nanostructure, comprising:
providing at least a nanoparticle containing a metal, wherein the nanoparticle is capable of transforming a light energy into a thermal energy;
distributing the nanoparticle onto a substrate;
coating a thermosetting material precursor on the substrate to cover the nanoparticle;
irradiating the nanoparticle with a light source to produce the thermal energy so as to cure a portion of the thermosetting material precursor around the nanoparticle to form a thermosetting material layer on the nanoparticle; and
removing the uncured portion of the thermosetting material precursor.

12. The method of claim 11, wherein the metal is selected from a group comprising silver, gold, copper, or the combination of which has surface plasmon resonance absorption.

13. The method of claim 11, wherein the nanoparticle further contains an inorganic substance or an organic substance.

14. The method of claim 11, wherein the thermosetting material precursor comprises un-polymerized monomer, un-crosslink oligomer and un-crosslink polymer.

15. The method of claim 11, wherein the step for immobilizing the nanoparticle onto the substrate comprises chemical bonding and physical adsorption.

16. The method of claim 11, wherein the thickness of the material layer is about 1˜100 nanometers.

17. The method of claim 11, wherein the light source is selected from a group comprising a laser and a light beam of light emitting diode.

18. A method for forming a core-shell nanostructure, comprising:
providing at least a nanoparticle containing a metal, wherein the nanoparticle is capable of transforming a light energy into a thermal energy;
mixing the nanoparticle with a thermosetting material precursor;
irradiating the nanoparticle, which have been mixed with the thermosetting material precursor, with a light source to produce the thermal energy so as to cure a portion of the thermosetting material precursor around the nanoparticle to form a thermosetting material layer on the nanoparticle; and
removing the uncured portion of the thermosetting material precursor.

19. The method of claim 18, wherein the metal is selected from a group comprising silver, gold, copper, or the combination of which has a surface plasmon resonance.

20. The method of claim 18, wherein the nanoparticle further contains an inorganic substance or an organic substance.

21. The method of claim 18, wherein the thermosetting material precursor comprises un-polymerized monomer, un-crosslink oligomer and un-crosslink polymer.

22. The method of claim 18, wherein the thickness of the material layer is about 1˜100 nanometers.

23. The method of claim 18, wherein the light source is selected from a group comprising a laser and a light beam of light emitting diode.
